(19) United States
(12) Patent Application Publication
(10) Pub. No.: US 2013/0077630 A1
(43) Pub. Date: Mar. 28, 2013

(54) ENERGY EFFICIENT CONNECTIONLESS ROUTING WITH SIMPLE LOOKUP

(71) Applicants: Yigal Bejerano, Springfield, NJ (US); Andrea Francini, Mooresville, NC (US)

(72) Inventors: Yigal Bejerano, Springfield, NJ (US); Andrea Francini, Mooresville, NC (US)

(21) Appl. No.: 13/247,477

(22) Filed: Sep. 28, 2011

(51) Int. Cl. H04L 12/56

(52) U.S. Cl. 370/392

(57) ABSTRACT

An energy efficient connectionless routing method with simple lookup is disclosed for reducing the number of address lookups associated with a message packet. The energy efficient connectionless routing method with simple lookup includes determining a label sequence which will allow the message packet to traverse a plurality of MPLS domains and affixing the label sequence to the header of the message packet. This allows the message packet to traverse a plurality of MPLS domains without requiring a subsequent IP address lookup at every MPLS domain boundary. The energy efficient connectionless routing method with simple lookup is particularly useful for reducing power consumption associated with TCAM operations during IP address lookups. In addition, a Label Sequencing Edge Router is disclosed for performing the method.

### FIELD OF THE INVENTION

The invention relates to generally to packet routing and is particularly concerned with a method of packet routing requiring a single lookup to traverse multiple access domains.

### BACKGROUND OF THE INVENTION

Packet classification, which includes IP lookup, is one of the critical operations of Internet Protocol (IP) routers with respect to scalability and energy consumption. When a packet arrives to a router line card, its header information is inspected for packet classification. The packet classification operation identifies the packet's next-hop router and determines the quality of service that the packet should experience. To keep up with the ever-increasing demand for Internet traffic, the capacity of a router's line interfaces must also keep increasing. The packet classification operation must therefore be completed within time intervals that are becoming shorter and shorter. For instance, in the case of a 100 Gbps line card the classification of packets should be completed in 3 nanoseconds (3×10-9 seconds). However, packet classification is a non-trivial function. A router needs to find the longest prefix match between the destination (and possibly also the source) address of the IP packet and the set of prefixes that are stored in the IP forwarding table of the router. Fast packet classification is substantially more challenging for IP version 6 (IPv6) packets, where the length of an IP address is 128 bits (the same length is 32 bits in IPv4 packets).

Today, there are three main approaches for packet classification; trie-based, hash-based, and TCAM-Based schemes (TCAM stands for Ternary Content Addressable Memory). The TCAM-based approach is the fastest, and the only one that guarantees to find the longest prefix match within a very short (and fixed) time. For this reasons the TCAM-based scheme has become de-facto the preferred solution in the industry for packet classification. TCAMs are fully associative memories that allow a “don't care” state to be stored in each memory cell in addition to 0's and 1's. As such, they are attractive for finding longest prefix matches. When an IP lookup is done on a given IP address, a TCAM chip checks simultaneously all of its entries and finds all the entries that match the given address. Among those entries, it returns the one with the lowest index. If the IP prefixes are stored in order by decreasing length, the retrieved prefix with the lowest index is the longest match for the target IP address. A single one-clock TCAM access is sufficient to complete an IP lookup operation.

Despite their support for high-speed packet classification, TCAMs suffer from significant limitations:

1) Very high power consumption due to parallel search of the all the TCAM entries at each lookup execution. As a result, TCAMs absorb 30%-40% of the power consumption of a router's line card just for supporting fast packet classification. Currently, a typical high-density TCAM chip consumes as much as 12 to 15 Watts when router vendors may deploy more than one TCAM chip per line card, while the overall power consumption of a line card is around 30-40 Watts. Note that the power consumption of a TCAM chip is linearly proportional to the size of the memory. Thus, as the number of TCAM chips in a line card increases with the need to support IPv6 (with an address space of 128 bits versus the 32 bits of IP version 4) and a much larger number of prefixes, so does also the power consumption of the line card.

2) TCAMs are very expensive components. Their high power consumption requires the deployment of additional power supplies and cooling devices, with further contribution to the engineering and operation costs.

3) The cell density of TCAM chips is low because of the need to support the “don't care” state. As a result, TCAMs contain more transistors relative to other memory types of the same size, which implies bigger chips.

Fast IP lookup is critical for scaling the capacity of IP routers with ever-increasing IP traffic demands. Out of all solutions available, TCAMs are best positioned to sustain the required speed of IP lookups. However, TCAMs contribute a substantial portion of the overall power consumption of a router.

A partial solution for simplifying the packet classification process may be found described in the usage of Multiprotocol Label Switched (MPLS) tunnels as per RFC 3031. In this technology a set of tunnels, also called Label Switched Paths (LSPs), are provisioned between the routers. Each MPLS tunnel is identified by a label. The label is included in a shim MPLS header of 4 bytes that is inserted in each packet between the Medium Access Control (MAC) header and the IP header of the packet. The label in the shim MPLS header is 20-bit long. It identifies the MPLS tunnel that the packet belongs to. Other fields in the header identify the tunnel type and the traffic class of the packet. As a result, with MPLS an IP packet is processed and classified only at the entry router to an MPLS tunnel, the entry router being termed a Label Edge Router (LER). As long as a packet traverses the same MPLS tunnel, the intermediate routers, termed Label Switching Routers (LSRs), use the label in the MPLS header for classifying the packet and determining the packet next hop. The MPLS label is in practice an index to the router forwarding table, where all relevant tunnel information is stored.

MPLS avoids the need to look for longest prefix matches, which is the requirement for using TCAMs in router line cards. Along the network path of an MPLS LSP, packet classification is only required at the LER's that define the entry and exit points of the LSP.

Since a packet typically traverses several MPLS domains (5 or more) this approach amounts to a partial solution as the IP lookup must be repeated at each LER along the route.

Referring now to FIG. 1 there may be seen an illustration of a network 100 that illustrates the route of a packet from origin 101 to destination 109 along multiple MPLS domains 110, 120, and 130. Each domain has a respective entry Label Edge Router 111, 121, and 131 respectively, and a respective exit Label Edge Router 117, 127, and 137 respectively. Within the domains may be seen Label Switched Routers 113 and 115, 123 and 125, and 133 and 135 for domains 110, 120, and 130 respectively. The packet commences from the origin 101 with a header 102 having an IP (source, destination) header 102. At entry LER 111 a lookup is performed and an MPLS label 112 is appended to the packet and used to direct the packet across LSRs 113 and 115 of the domain 110. At exit LER 117 the MPLS label L₁ is stripped from the packet and the packet proceeds to the next domain 120 in IP form 104. At entry LER 121 a lookup is performed and an MPLS label 122 is appended to the packet and used to direct the packet across LSRs 123 and 125 of the domain 120. At exit LER 127 the MPLS label L₂ is stripped from the packet and the packet proceeds to the next domain 130 in IP form 106. At entry LER 131 a lookup is performed and an MPLS label 132 is appended to the packet and used to direct the packet across LSRs 133 and 135 of the domain 130. At exit LER 137 the MPLS label L₃ is stripped from the packet and the packet proceeds to the destination 109 in IP form 108.

As the figure shows, the packet requires an energy consuming IP lookup operation at each entry LER along the path from the origin 101 to the destination 109.

A simple extension of the MPLS-based solution that relies on end-to-end MPLS tunnels is proposed in [RFC 5151]. In this solution a dedicated MPLS tunnel is provisioned between the source (or the access router near the source) and the destination (or the closest access router to the destination). This MPLS tunnel may use other existing MPLS tunnels between the LERs of MPLS domains along the route of the end-to-end tunnel. This concatenation of tunnels is supported by the hierarchical tunneling capabilities of MPLS [RFC 3031]. In this solution a single IP lookup is performed at the access router and all the subsequent routers use the MPLS label for determining the packet's next hop. Note that this is an end-to-end connection-oriented solution. As such, it suffers from several drawbacks;

(a) Each LER in every MPLS domain along an end-to-end tunnel must maintain state information for the tunnel. The number of end-to-end tunnels that traverse an LER can be very large. For evaluation of the size of the label information base (LIB) needed in this case, let us assume that the access router associated with every end network (prefix) has an end-to-end tunnel with the access router of every other end network. With N end networks, the size of the LIB of some LERs may be of order of N². Instead, for IP address lookup the number of prefixes is bounded by N. This implies that a solution based on end-to-end tunnels is not scalable.

(b) Another critical limitation is the need for collaboration agreements between ISPs and for inter-domain signaling.

(c) While the solution may be attractive for long-lasting MPLS tunnels, such as for inter-domain Virtual Private Network (VPN) services like the Virtual Private LAN Service (VPLS), it is impractical for support of short transactions between end hosts such as web browsing, content download/streaming, etc.

Therefore, it would be desirable to have a method or apparatus capable of enables the replacement of TCAM-based packet classification with a much simpler and less power-hungry packet classification method in most network routers, reducing the overall power consumption of the IP network.

### SUMMARY OF THE INVENTION

It is an object of the invention to provide a method and apparatus of packet classification which yields energy savings for a network.

According to an aspect of the invention there is provided a method of routing a message packet having a destination address across a plurality of MPLS domains in a network, the method having the steps of receiving the message packet at an ingress port of a Label Sequencing Edge Router; determining by the Label Sequencing Edge Router based upon the destination address a Label Sequence sufficient to traverse those intervening MPLS domains of the plurality of MPLS domains between the Label Sequencing Edge Router and the destination address; modifying by the Label Sequencing Edge Router the header of the message packet by affixing the Label Sequence to the header; and forwarding by the Label Sequencing Edge Router the message packet with modified header into the MPLS tunnels denoted by the Label Sequence.

In some embodiments of the invention the Label Sequence has a plurality of MPLS shim headers and each MPLS shim header contains a label identifying a respective tunnel of the intervening MPLS domains. In some related embodiments the MPLS shim headers are inserted in an order with respect to the sequence of the intervening MPLS domains along the packet route defined by the Label Sequence. In some of these embodiments the order is a reverse order with respect to the sequence of the intervening MPLS domains along the packet route defined by the Label Sequence such that the outer label closest to the MAC header identifies a tunnel in the first MPLS domain to be traversed, and such that the innermost label closest to the IP header identifies a tunnel in the last MPLS domain to be traversed.

In some embodiments of the method rein an egress Label Edge router at a peering point between an adjacent pair of intervening MPLS domains performs the additional steps of modifying the Label Sequence within the header of the message packet; and subsequently forwarding the message packet to the adjacent MPLS domain. According to some of these embodiments the modifying step is removing the topmost remaining MPLS shim header.

According to yet another embodiment the determining step has the Label Sequence Edge Router retrieving a Label Sequence from a data store according to the destination address. In some of these embodiments, when during the cannot locate a Label Sequence in the data store, then the Label Sequence Edge Router performs the additional step of initiating a Label Sequence discovery process. This initiating step may involve requesting a Label Sequence from a Path Computation Element. In some embodiments the Path Computational Element is an element in a centralized Path Computational Element architecture, while in other embodiments the Path Computational Element is an element in a distributed Path Computational Element architecture.

According to another aspect of the invention there is provided a Label Sequencing Edge Router for forwarding a message packet having a destination address across a plurality of MPLS domains in a network, the Label Sequencing Edge Router having an ingress port for receiving the message packet; a Label Sequence data store for storing Label Sequences appropriate to specific destination addresses; a header modifier for modifying the header of the message packet by affixing a Label Sequence retrieved from the Label Sequence data store; and an egress port for forwarding the message packet with modified header into the MPLS tunnels denoted by the Label Sequence.

In some embodiments the Label Sequencing Edge Router further has a Label Sequence requester for requesting Label Sequences from a Path Computation Element. In some of these embodiments the Label Sequence requester is adapted for requesting Label Sequences from a centralized architecture Path Computation Element, while in other embodiments the Label Sequence requester is adapted for requesting Label Sequences from a distributed architecture Path Computation Element.

An article of manufacture for use in programming a Label Sequencing Edge Router, the article of manufacture comprising tangible and non-transitory computer useable media accessible to the Label Sequencing Edge Router, wherein the computer useable media includes at least one computer program that is capable of causing the Label Sequencing Edge Router to perform the steps of receiving a message packet having a destination address at an ingress port of said Label Sequencing Edge Router; determining by said Label Sequencing Edge Router based upon said destination address a Label Sequence sufficient to traverse those intervening MPLS domains of said plurality of MPLS domains between said Label Sequencing Edge Router and said destination address; modifying by said Label Sequencing Edge Router the header of said message packet by affixing said Label Sequence to said header; and forwarding by said Label Sequencing Edge Router said message packet with modified header into the MPLS tunnels denoted by said Label Sequence.

According to some embodiments the article of manufacture contains instructions wherein the Label Sequence comprises a plurality of MPLS shim headers and wherein each MPLS shim header contains a label identifying a respective tunnel of said intervening MPLS domains. In some of these the MPLS shim headers are inserted in an order with respect to the sequence of the intervening MPLS domains along the packet route defined by the Label Sequence. In some of these embodiments the order is a reverse order with respect to the sequence of the intervening MPLS domains along the packet route defined by the Label Sequence such that the outer label closest to the MAC header identifies a tunnel in the first MPLS domain to be traversed, and such that the innermost label closest to the IP header identifies a tunnel in the last MPLS domain to be traversed.

Note: in the following the description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

### BRIEF DESCRIPTION OF THE DRAWINGS

The present invention will be further understood from the following detailed description of embodiments of the invention, with reference to the drawings in which:

FIG. 1 illustrates address lookup operations for a packet traversing a network with multiple MPLS domains according to the prior art;

FIG. 2 illustrates an example of an MPLS tunnel that ends at the egress port of a Label Edge Router according to the prior art;

FIG. 3 illustrates packet forwarding with a single IP lookup in accordance with an embodiment of the present invention;

FIG. 4 illustrates a centralized Path Computational Element architecture for Label Sequence Discovery in accordance with an embodiment of the present invention;

FIG. 5 illustrates traffic tunnels in a domain for user traffic and management traffic in accordance with an embodiment of the present invention;

FIG. 6 illustrates a distributed Path Computational Element architecture for Label Sequence Discovery in accordance with an embodiment of the present invention;

FIG. 7 illustrates fast and local recovery from failures in accordance with an embodiment of the present invention;

FIG. 8 illustrates a graph of AS hop-count distribution statistics as might be encountered by embodiments of the present invention; and

FIG. 9 illustrates a graph of AS hop-count distribution statistics as might be encountered by embodiments of the present invention from a different source than that of the statistics of FIG. 8.

### DETAILED DESCRIPTION

in the following figures, like reference numbers are used to represent like elements.

The following embodiments of the invention will be described with respect to a network with multiple (Multiprotocol Label Switching) MPLS domains. In the network all the routers support the MPLS standards and every router is either a Label Edge Router (LER) at the boundary of an MPLS domain or a Label Switched Router (LSR) in the middle of an MPLS domain. Access routers may be considered LERs of an MPLS domain. Every IP packet sent by a host is assigned to an MPLS tunnel by the first access router along its route to the destination host. At every boundary between MPLS domains, the packet transfers from the exit of one MPLS tunnel to the entry of a new MPLS tunnel, until it reaches the access router that serves the destination host.

According to an embodiment of the invention, the transfer between consecutive MPLS tunnels occurs without IP lookup. As a consequence, only the access routers need to support IP lookup capabilities (and possibly include TCAMs in their line cards). During operation of embodiments of the invention, the other routers, and in particular the LERs between MPLS domains, are no longer required to perform IP lookups.

For descriptive purposes, it is assumed that each peering point (the connection point between two adjacent MPLS domains) contains two LERs, one LER per domain. Also, for the purposes of description it is assumed that every adjacent MPLS domain has at least two peering points. Note that these are reasonable assumptions that are satisfied by common network designs. These assumptions can be easily relaxed for any general case i.e. are not fundamental to operation of embodiments of the invention.

The operation of embodiments of the invention utilize the following features of the MPLS standard:

MPLS Label Stacking. Embodiments of the invention utilize the label stacking capability of MPLS [RFC 3031, Clause 3.9]. MPLS allows a packet to carry multiple labels (included in respective MPLS “shim” headers, so called because they may be stacked metaphorically as per mechanical “shims”), organized as a last-in-first-out (LIFO) stack and referred to as the “label stack”. This label stacking feature is used for supporting MPLS hierarchies; however, according to the standard [RFC 3031]: “The processing of a labeled packet is completely independent of the level of hierarchy. The processing is always based on the top label, without regard for the possibility that some number of other labels may have been ‘above it’ in the past, or that some number of other labels may be below it at present.” The MPLS label stacking feature provides for independent processing of labels by the different routers along a packet route.

Tunnel end at an egress port. Another MPLS feature utilized in embodiments of the invention is the capability to terminate an MPLS tunnel at the egress port of an LER. Embodiments of the invention take advantage that an MPLS tunnel starts at an ingress port of an LER and ends at an egress port of an LER. Referring to the sub-network 200 of FIG. 2, there may be seen an MPLS domain 210 which receives packets from source 201 external to the MPLS domain. The packets are received at an ingress port of LER 211, the appropriate MPLS tunnel label “L_{X}” determined by LER 211, and then sent across the domain 210 in the MPLS tunnel via LSRs 213 and 215 which using the L_{X} label route the packet to egress LER 217. The tunnel ends at the egress port of LER 211, which means that LER 211 uses the MPLS label of the packet to determine the next-hop router (which is LER 209) and then removes the MPLS shim header with the label from the packet before forwarding the packet to LER 209. This behavior complies with the Penultimate Hop Popping (PHP) feature of MPLS (see RFC 3031, Clause 3.16).

The Label Sequence Concept used in Embodiments of the Invention

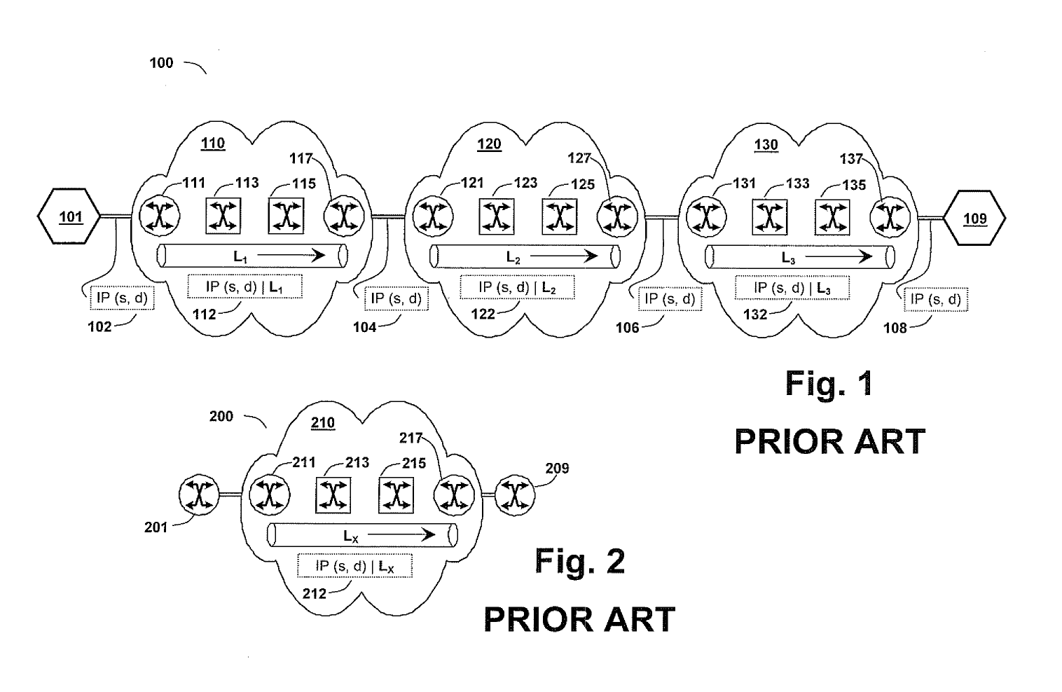

Consider a traffic flow between a source and a destination host that traverses a number “K” MPLS domains, as illustrated in FIG. 1 above (where K assumed the value 3). In embodiments of this invention, when a packet of the flow arrives to the first access router, called a Label Sequence Edge Router (LSER), the LSER inserts a quantity K MPLS shim headers with respective tunnel labels just before the IP header of the packet. The set of MPLS labels added by the LSER is denoted a label sequence (LS). Each label in the LS identifies a specific MPLS tunnel within one of the K MPLS domains along the packet route. The labels are inserted in reverse order with respect to the sequence of MPLS domains along the packet route, such that the top (outer) label (closest to the MAC header) identifies the tunnel in the first MPLS domain and the bottom label (closest to the IP header) identifies the tunnel in the last MPLS domain along the packet route. Every time the packet reaches the egress LER of an MPLS tunnel, the egress LER removes the current top label from the stack (label pop operation) and forwards the packet to the ingress LER of the next MPLS domain. By definition of the label sequence, the new top label after a pop operation identifies the MPLS tunnel that the packet will use to traverse the next MPLS domain.

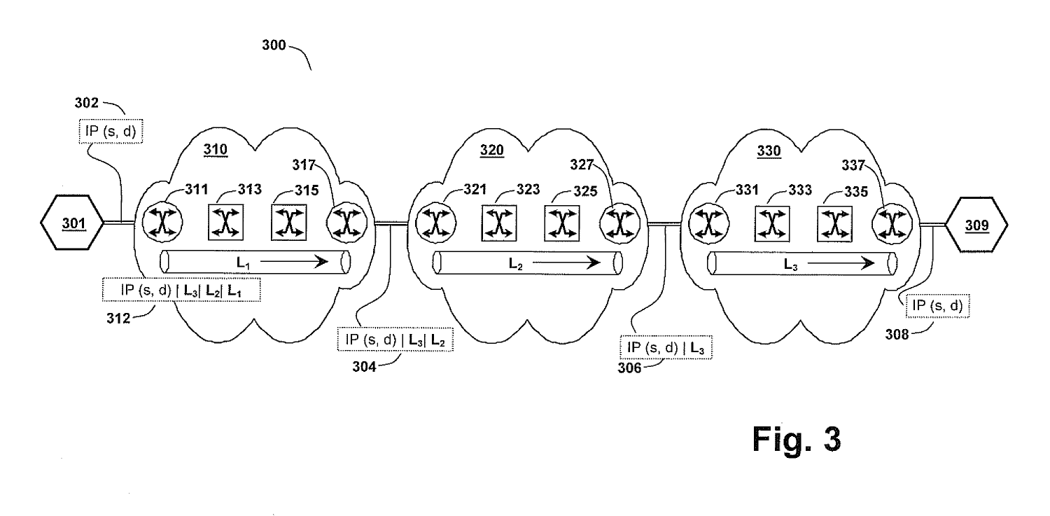

Referring now to FIG. 3, there may be seen an illustration of how packet forwarding works with the label sequence concept according to an embodiment of the invention. FIG. 3 depicts a network 300 having a source 301 which forwards packets across three distinct MPLS domains 310, 320 and 330 to destination 309. Initially, the packet is sent by the source 301 to the LSER 311 in IP (source, destination) packet format 302. The LSER 311 adds to the packet three MPLS shim headers with respective tunnel labels: L₁, L₂, and L₃ generating a packet header 312. Within the label sequence, L₁ is the top label and identifies the MPLS tunnel for the first MPLS domain 310. L₂ is the second label and identifies the MPLS tunnel for the second MPLS domain 320. L₃ is the bottom label that identifies the MPLS tunnel for the third and last MPLS domain 330. The LSER sends the packet along the tunnel identified by L₁ which in this example means the packet traverses LSRs 313 and 315. When the packet arrives at the exit LER 317 of the first domain 310, the LER 317 removes the MPLS shim header with label L₁ (PHP operation) and sends the resulting packet 304 to the entry LER 321 of the second MPLS domain 320.

LER 321 forwards the packet according to the label L₂ which in this example means that the packet traverses domain 320 via LSRs 323 and 325 to arrive at LER 327. When the packet reaches LER 327, it removes the label L₂ (another PHP operation) and sends the resulting packet 306 to the entry LER 331 of the third MPLS domain 330.

Within the third MPLS domain 330, the packet is routed according to the label L₃ which in this example means that the packet traverses domain 330 via LSRs 333 and 335 to arrive at LER 337. LER 335 removes the last MPLS shim header with label L₃ and sends the IP packet 308, now without MPLS shim headers, to the destination node 309.

The packet classification method of embodiments of the present invention presents several advantages compared to other packet classification methods. Besides enabling energy and cost saving as will be explained infra, the proposed scheme provides an elegant solution to a critical need of the industry that may not be easily resolved by other solutions.

Alternative embodiments of the present invention offers at least some of the following benefits:

Cost savings and energy savings by elimination of expensive and power-hungry TCAMs from the line cards of core routers. In the described embodiments, every IP packet undergoes the packet classification process only once, at the Label-Sequence Edge Router (LSER). As a consequence, only the LSER needs to perform complex packet classification operations such as longest prefix matching for IP addresses. Every other router along the packet route uses the label of the packet's top MPLS header to find in its forwarding table the packet's next hop and its expected quality of service. With the proposed solution, the number of TCAM chips or multi-core processors needed in the network is drastically reduced, with substantial savings in engineering costs and energy consumption.

Full Compliance with Existing IETF RFCs (Standards).

Connectionless paradigm for end-to-end communication. Existing network-based solutions rely on the establishment of end-to-end connections or tunnels. Instead, the label sequences of embodiments of the invention do not rely on awareness of inter-domain connections in the routers of the network, or on the knowledge of the tunnels that connect the LERs of different MPLS domains. The connectionless paradigm for end-to-end communication yields the following advantages:

Scalability—The routers are not required to maintain state information for end-to-end connections that span across all MPLS domains in the network. Solutions that require maintaining such state information face serious scalability limitations.

No need for inter-ISP coordination—The scheme does not require coordination among the ISPs that control the various MPLS domains for establishment and management of the cross-domain tunnels.

Ease of implementation. Several of the embodiments of the invention can be easily integrated in existing/deployed routers.
Of all the functional components of the solution, only the LSERs may require some minor hardware upgrade. The LSER maps IP headers onto label sequences. To perform the mapping, the LSER must include the label sequences in its IP forwarding table. Storage of the label sequences may require additional standard memories (SRAM or DRAM) on the line cards of the LSER. Within the MPLS domains, the LSRs and the LERs that do not have LSER responsibilities operate as ordinary LSRs and LERs and thus do not require hardware upgrades.
In the implementation with a Centralized PCE (Path Computational Element) for label sequence discovery, some core routers may need configuration adjustments to ensure that each tunnel ends at the egress LER of the next domain.
In the implementation with a Distributed PCE for label sequence discovery, both software and configuration updates are required in the core routers for supporting the label-sequence discovery process.

The two options available for the Label-Sequence Discovery Process (Centralized PCE and Distributed PCE) are presented in the next section.

Following are several implementation details for a packet forwarding scheme based on the label sequence concept. The first MPLS-capable node along the packet route between two hosts is referred to as a Label Sequence Edge Router (LSER) in the following discussion. The LSER is typically the access router that serves the source node, but it may also be the source node itself.

This section addresses the following aspects of embodiments of the invention:
Label sequence discovery
Handling of packets during the discovery of a new label sequence
Fault recovery
Minor implementation details.

Discovery of the Label Sequence Between a Source and a Destination

When an IP packet arrives at an the LSER, the latter performs IP lookup for classifying the packet and finding a longest-prefix matching entry in its forwarding table. In the event that a matching entry in the forwarding table is already associated with a label sequence, the label sequence is pushed in the packet header and the packet is forwarded to the destination node with the help of the label sequence as described in relation to FIG. 3 supra.

If, instead, the label sequence is not known to the LSER (i.e., no label sequence is associated with the matching entry in the forwarding table), the LSER starts the Label Sequence Discovery Process (LSDP) to acquire the label sequence that should be associated with the matching entry.

Following are presented two alternative embodiments for discovering the label sequence that leads from an LSER to a target destination. These methods are aligned with the Path Computation Element (PCE) based Architecture described in [RFC 4655].

As recited in [RFC 4655], embodiments of the present invention presume that every MPLS domain contains one or more PCEs. Each PCE is an entity (component, application, or network node) that is capable of computing a packet route based on the network topology graph and given routing constraints.

By way of example, consider a request for a route between source and destination nodes that are located at different MPLS domains. Each PCE along the path may have only partial visibility of the required end-to-end path. This means that every PCE needs to maintain enough information for selecting paths, or MPLS tunnels, across its associated domain, and to know the next domain along the path of a given source-destination pair.

The details following specify the support that is required from a PCE for discovery of the label sequence between a source and a destination.

Consider two common PCE types:

Distributed PCE: Every LER supports PCE functionality.

Centralized PCE: The PCE functionality is provided by dedicated nodes. Typically there are one or more PCE nodes within each MPLS domain to configure the forwarding tables of the routers.

The proposed methods for label-sequence (LS) discovery infer two label sequences for every unmatched packet. The first LS, called the forward label sequence (FLS), specifies the path from the LSER to the destination node. The second LS, called the reverse label sequence (RLS), specifies the path from the LSER of the destination node to the source node. The reason for constructing both label sequences is that in most cases a packet that flows from a source to a destination triggers the creation of a packet flow in the opposite direction. It is then appropriate in many embodiments to ensure that also the LSER for the reverse direction is provided with an up-to-date label sequence for reaching the source of the first packet.

Label-Sequence Discovery Process with Centralized PCEs

In this version of the LSDP, it is assumed that the LERs do not have PCE capabilities and that each MPLS domain contains one or more dedicated PCE nodes. To simplify the description it is presumed that the inter-PCE communication model presented in RFC 4655, Clause 5.4, is employed, and that PCE nodes of adjacent domains are connected by tunnels. However, the LS discovery process is not limited to the communication model presented in RFC 4655, but works well with more general connectivity models for the PCEs.

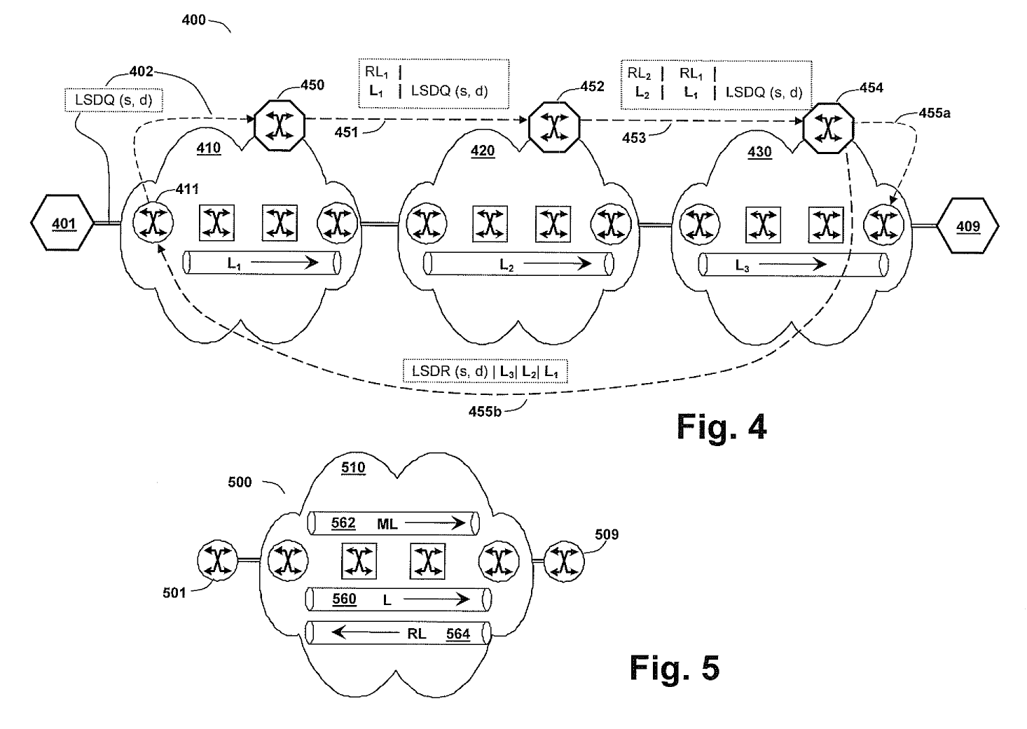

Referring now to FIG. 4, the LSDP with Centralized PCEs in a network 400, works as follows according to an embodiment of the invention.

Consider a packet sent from a source node 401 to its SLER 411 as in FIG. 4. Since the LSER 411 does not find an LS instance associated with the entry in the forwarding table that matches the packet header, the LSER 411 generates an LS Discovery Request (LSDQ) message 402 that contains the IP header of the packet, including the source and destination IP addresses. In addition, the packet contains empty fields for the forward and reverse label sequences. Next, the LSER sends the LSDQ message 402 to its PCE node 450. Based on the contents of the IP header embedded in the LSDQ message 402, the PCE node 450 identifies the next MPLS domain (or destination node) for the LSDQ message, and the peering point with that domain. The PCE node 450 pushes into the LSDQ message the label of a tunnel from the LSER to the peering point as the top label of the FLS, the label of a tunnel from the peering point to the source node 401 as the bottom label of the RLS. Then, the PCE sends the modified LSDQ message 451 to the PCE node 452 of the next MPLS domain 420 with the indication of the peering point between the two domains (i.e., the tunnel-tail LER).

Generally speaking, when a PCE node gets an LSDQ message, it identifies the next domain (or destination node) for the IP header in the message and the intra-domain MPLS tunnels between the peering points between the domain and the previous and next domains in the packet route. After the labels of these tunnels are added to the FLS and RLS, the LSDQ is forwarded to the PCE of the next MPLS domain. This process is shown by LSDQ 453 in FIG. 4.

The PCE node 454 of the destination domain 430 finds the tunnel between the last peering point and the access router adjacent to the destination node, which is the reverse LSER. Then it updates the FLS and RLS from the LSDQ message and includes them in an LS Discovery Response (LSDR) message 455a and 455b that it sends to the forward and reverse LSERs. Both LSERs update their IP forwarding tables with the inferred label sequences. These two messages are shown as messages 455a and 455b.

Note that the embodiment depicted in FIG. 4 does not specify the path followed by the LSDR message from the last PCE node 454 to the LSER 411 that initiated the discovery process. This message can choose from multiple paths to reach its destination. For instance, it can travel through the PCE-nodes encountered by the LSDQ message, in reverse order.

Label-Sequence Discovery Process with Distributed PCEs

This subsection describes the LS Discovery Process in the case of Distributed PCEs. In this case the forward and reverse LS are populated by the LERs along the packet route. It is presumed that a pair of tunnels exists between every pair of LERs in an MPLS domain for exchange of management traffic.

Referring to FIG. 5, an MPLS domain 510 receives packets from LER 501 and will be passing them to LER 509, both exterior to domain 510. The forward tunnel 460 and reverse tunnel 464 for user traffic are labeled “L” and “RL”. One tunnel 462 for management traffic from ingress LER to egress LER is labeled “ML”.

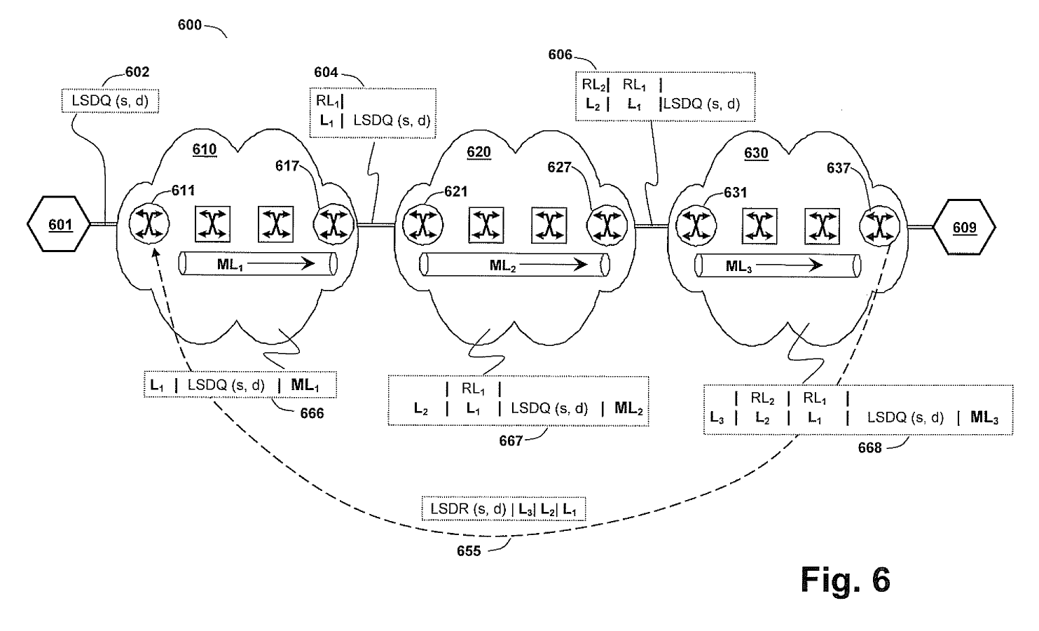

An embodiment for LDSP with Distributed PCEs is illustrated FIG. 6.

Initially LSER 611 receives an IP packet whose matching entry in the forwarding table does not have an associated label sequence. However, the LSER 611 knows the next MPLS domain that the packet must traverse to reach its destination, and the tunnel that can take the packet to the peering point with that domain. In the example embodiment illustrated in FIG. 3, this tunnel is labeled “L₁” and ends at the egress port of LER 317. The LSER 611 generates an LSDQ message 604 that contains the IP header of the packet and place holders for the FLS and RLS. The LSER 611 initializes the FLS with the label of the tunnel for user traffic between the LSER and the egress port of LER 617 as the top label. The LSER 611 leaves the RLS field empty. The LSER 611 sends the LSDQ message 604 to LER 617 along the management tunnel (labeled “ML₁”) between SLER 611 and LER 617.

Upon receipt of the LSDQ message 604, LER 617 identifies the MPLS tunnel of the reverse path to the LSER and adds its label (“RL₁”) as the bottom label of the RLS. Then it forwards the LSDQ message 604 to its adjacent LER 621 at the next MPLS domain 620 along the route identified by the PCE records maintained by the LER.

In general, when an LER gets an LSDQ message it performs the following operations:

Case I: The LER is the head of an MPLS tunnel in the forward direction, i.e., the LSDQ message arrived from an adjacent LER in a different domain. The LER uses its PCE information to identify the next domain, the peering point with that domain, and the tunnel for user traffic to that peering point. It adds the label of that tunnel to the forward label sequence as the bottom label, and forwards the updated LSDQ message to the same LER using the management tunnel.

Case II: The LER is the tail of an MPLS tunnel in the forward direction, i.e., the LSDQ message arrived from another LER in the same MPLS domain. The LER uses its PCE information to identify the MPLS tunnel for user traffic in the reverse direction. It adds the label of that tunnel to the RLS in the LSDQ message, as the top label. Finally the LER forwards the LSDQ message to the adjacent LER at the peering point with the next domain.

The last LER (LER 637 in FIG. 6) along the path from the source to the destination, which is typically the access router of the destination node, is also the LSER of the reverse path, or the Reverse LSER.

When the LSDQ message arrives at the Reverse LSER, the Reverse LSER updates the RLS with the label of the reverse MPLS tunnel at the destination domain as the top label. Then it stores the RLS in its forwarding table, next to the entry that matches the source IP address in the header contained in the LSDQ message. Finally, it sends to the Forward LSER (i.e., the LSER that initiated the discovery process, LSER 611 in FIG. 6), an LS Discovery Response (LSDR) message 655 that contains the FLS.

When the Forward LSER 611 receives the LSDR message 655, it stores the FLS in the forwarding table, next to the entry that matches the IP destination address in the header of the packet whose reception triggered the LSDP.

Handling of Packets with Unknown Label Sequence

When the LSER detects a message with unknown label sequence, it initiates the LS Discovery Process. Since the LS remains unknown for the entire duration of the process, the handling of the packet up to completion of the LSDP remains to be specified. Embodiments of the present invention contemplate two distinct approaches:
a. The LSER holds the packet: The LSER holds the packet until it receives the LSDR message with the missing label sequence for updating the forwarding table. This approach is has proven useful in other discovery protocols such as the Address Resolution Protocol (ARP) [RFC 826].
b. The LSER sends the packet along with the LSDQ message: The LSER embeds the packet in the LSDQ message. Note that the LSDQ message is already required to carry the IP header of the packet. The difference in this case is that the LSDQ also needs to include the payload of the packet. When the LSDQ message reaches the last PCE node or the Reverse LSER, the packet is extracted from the LSDQ message and forwarded to its destination.

It is also possible for the LSER to receive not just one packet but a burst of packets aiming for the same destination before their label sequence is discovered and applied to the forwarding table. In such a case an LSER that holds the packets with unknown LS should cache all packets pending transmission in a dedicated memory space. An LSER that embeds the packet in the LSDQ message could instead trigger multiple unnecessary LSDP instances aiming for the same label sequence, possibly overloading the network slow path, a less preferred alternative.

In practice, this inconvenient situation is extremely unlikely to occur. In a vast majority of inter-host communications, the first packet typically carries a request for connectivity with the remote host. This is definitely the case for applications like web-browsing and content download/streaming. It is therefore very unlikely for a source node to send multiple packets to the same destination before getting a response to its first packet.

Note that with both approaches outlined for the handling of packets with unknown LS, the source host receives the response from the destination host only after the forward and reverse label sequences have been discovered.

Optimization of the LS-Discovery Process

Following is a description of a method for expediting the LS Discovery Process by reducing the number of PCEs that handle an LSDQ message. The aforegoing description presumes that only the Forward LSER checks its forwarding table (or cache) for the presence of a label sequence in association with the forwarding table entry that matches and incoming packet. During the LSDP execution, the LSDQ message propagates through all the PCE nodes along the path to the destination, with both Centralized and Distributed PCEs.

This process can be significantly improved by leveraging information obtained in prior executions of the LSDP process. When a PCE node receives an LSDQ message, the message already contains the FLS and RLS discovered so far between the Forward LSER and the PCE. When a PCE node receives an LSDQ message, according to some embodiments it has the option of storing for future use the FLS and RLS found in the message. When the PCE receives an LSDQ message for a destination network, it may already know both the missing portions of the FLS and RLS to and from the destination IP address in the LSDQ message. If both sequences are known, in some embodiments the PCE can intercept the LSDQ message and directly reply to the Forward LSER with complete forward and reverse label sequences.

Local and Fast Fault Recovery

Packet networks are required to ensure high degrees of service availability by means of fast fault recovery. Preferably, the forwarding scheme of embodiments of the present invention must not degrade the network capability to recover from link and node failures. This subsection describes a fault recovery mechanism that can be applied to the forwarding scheme.

The mechanism relies on the MPLS standards [RFC 3031], [RFC 4090] for ensuring very fast recovery from failures. The fault recovery mechanism is transparent to all network nodes with the exception of the two nodes that are adjacent to the failed component (link or node).

Two cases are considered:

Case I: The failure affects an internal component of an MPLS domain, such as an LSR or a link between routers in the same domain. Consider such a failure occurring at any MPLS domain along the path defined by a label sequence. In such a scenario the two end points (LERs) of the tunnel that is used within the domain of the failure are still operational.

For this kind of event MPLS provides a fast restoration solution called Fast Reroute (FR) [RFC 4090]. With MPLS Fast Restoration the node that is adjacent to the failed component in the upstream direction, referred to as the Point of Local Repair (PLR), detects the failure and deflects the traffic of the affected tunnel to an alternative, detour tunnel. The detour tunnel starts at the PLR and merges with the original tunnel at a merge point (MP) after the failed component. The embodiments of the present invention do not need new technologies to resolve such intra-domain failures.

Note that the execution of the Fast Reroute procedure relies on the merge operation of MPLS. Consider the scenario of two tunnels that end at the same node and intersect at any intermediate node (note that the only intersection point of the two tunnels may be endpoint shared by the two tunnels). MPLS allows the two tunnels to merge at the intermediate node, referred to as a merge point (MP). The MP combines the traffic of the two tunnels into a single tunnel by marking the packets coming from both tunnels with the same outgoing label, which keeps them in the same tunnel until they reach the tunnel endpoint. This merge operation is utilized in some embodiments of the present invention.

Case II: The failure affects an LER or a link between two LERs. This case is more challenging because it affects two MPLS domains and cannot be resolved by using intra-domain fast-reroute detours.

For a tunnel that traverses multiple MPLS domains the MPLS standards provide a mechanism for signaling inter-domain detours. Yet, embodiments of the present invention are based on the premise of minimal inter-domain coordination and in particular the embodiments prefer to avoid any cross-domain signaling. For recovery from such failure embodiments of the invention implement a scheme that is based on the fast-reroute and merge capabilities of MPLS. The scheme assumes that for fault recovery purposes every pair of adjacent domains are connected by two or more peering points.

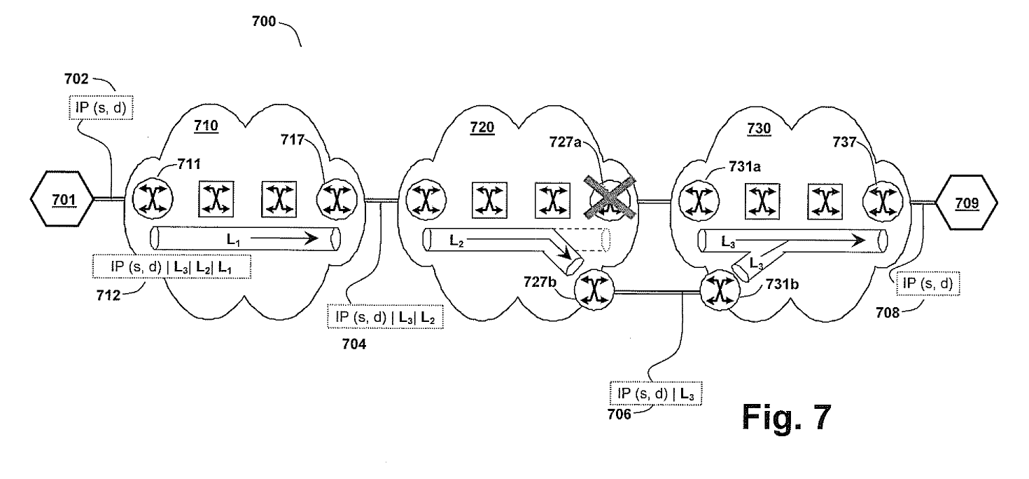

The network 700 of FIG. 7 may be used to illustrate the solution, which is described below for the case where a failure occurs in LER 727a of MPLS domain 720.

Fast Reroute Operation—Consider a failure of a link or a LER at a peering point. In FIG. 7 this is illustrated as a failure at LER 727a. In embodiments of the invention employing this scheme, the adjacent node to the failed component (in the upstream direction) becomes the Point of Local Repair and deflects the traffic to a detour path that ends at another peering point, called the alternative peering point, between the two affected domains. By itself such detour does not provide a recovery to the failed component since it ends at another peering point and it does not merge with the original traffic path. To ensure full recovery embodiments further employ the merge operation as described below.

Merge Operation—Consider two adjacent domains and the peering points between them. Now consider the tunnels that start at the peering points and end at any LER that is not one of these peering points. Note that any pair of these tunnels may share a merge point. For ensuring fast recovery embodiments of the invention requires that all these tunnels have the same value of the entry label at the LERs of the peering points. Any pair of such tunnels gets merged at some point, possibly at the end LER.

For instance, in FIG. 7 the middle MPLS domain 720 and the right MPLS domain 730 have two peering points. The two peering points are the starting point of two tunnels that end at LER 737 and merge at a merge point. To enable a fast recovery from the failure of a peering point, the two tunnels are marked with the same label, namely L₃ in FIG. 7

Using FIG. 7 the fast recovery mechanism provided by the two abovementioned operations may now be described.

Consider a label sequence “L₁, L₂, L₃” between a source host 701 and a destination host 709, and assume that the failure of a node/link occurs at the peering point between MPLS domains 720 and 730, as shown in FIG. 7. In the example in the figure, LER node 727a has experienced a failure. Any packet that travels through tunnel “L₂” is diverted by the PLR to the alternative peering point 727b.

Initially the source node 701 sends a packet 702 to the destination node 709. The Forward LSER 711 adds to the packet the LS as shown at 712 and sends the packet 712 to LER 717. LER 717 removes the label “L₁” and sends the packet along the tunnel labeled “L₂”. However, due to the failure at the peering point between domains 720 and 730, the tunnel labeled “L₂” is broken.

Consequently, the PLR deflects the packet to the detour that ends at LER 727b. Note that the packet reroute does not affect the value of the internal label, which remains “L₃”.

When the packet arrives to LER 727b, it loses the label “L₂” (or any other label that defines the detour) and gets forwarded to LER 731b as packet 706. Next the packet is forwarded along the tunnel from LER 731b to LER 737. Note that the entry label to this tunnel is also “L₃”. After the packet reaches the merge point it is forwarded along the same tunnel the serves the traffic from LER 731a to LER 737 (the Merge Point merges the traffic from the two peering points).

Note that the same label sequence is used for routing the packet also in the case of a failure, which demonstrates that there is no need to update any router with information regarding the failure with the exception of the PLR.

Additional Implementation Issue Details

This subsection addresses quality of service (QoS) and service vulnerability issues of embodiments of the invention.

Quality of service support: Different MPLS tunnels may provide different service types. For example there may be multiple MPLS tunnels between two LERs for supporting different QoS requirements. This implies that there may be multiple label sequences between a source and a destination, each LS defining a chain of MPLS tunnels that supports a specific QoS requirement.

Embodiments of the present invention may support different type of QoS requirements for different traffic flows by allowing the LSER to store multiple LSs for a given source-destination pair. Upon receipt of a packet, the LSER performs packet classification based on the entire IP header, not just the destination IP address. The outcome of the packet classification procedure includes the identification of the required type of QoS support, which contributes to the selection of the LS for the packet. Similarly, during execution of the LS Discovery Process the PCE nodes may use the IP header information in the same way to drive the construction of the FLS and RLS in the LSDQ message.

Evaluation of Performance

To evaluate the cost and energy savings of the proposed scheme relative to the prior art, there was an assessment of the reduced execution of IP lookup operations that it enables.

Today, every label edge router (LER) of an MPLS domain needs to perform packet classification (IP lookup) on every received packet in order to determine the appropriate MPLS tunnel for routing the packet. The potential cost and energy savings of the proposed scheme can be derived by consideration of the average number of MPLS domains that a packet traverses along the path to its destination. For a very conservative estimate of this number, it may be assumed that every autonomous system (AS) contains a single MPLS domain. Note that in practice every MPLS domain is included in a single AS but an AS may include multiple MPLS domains.

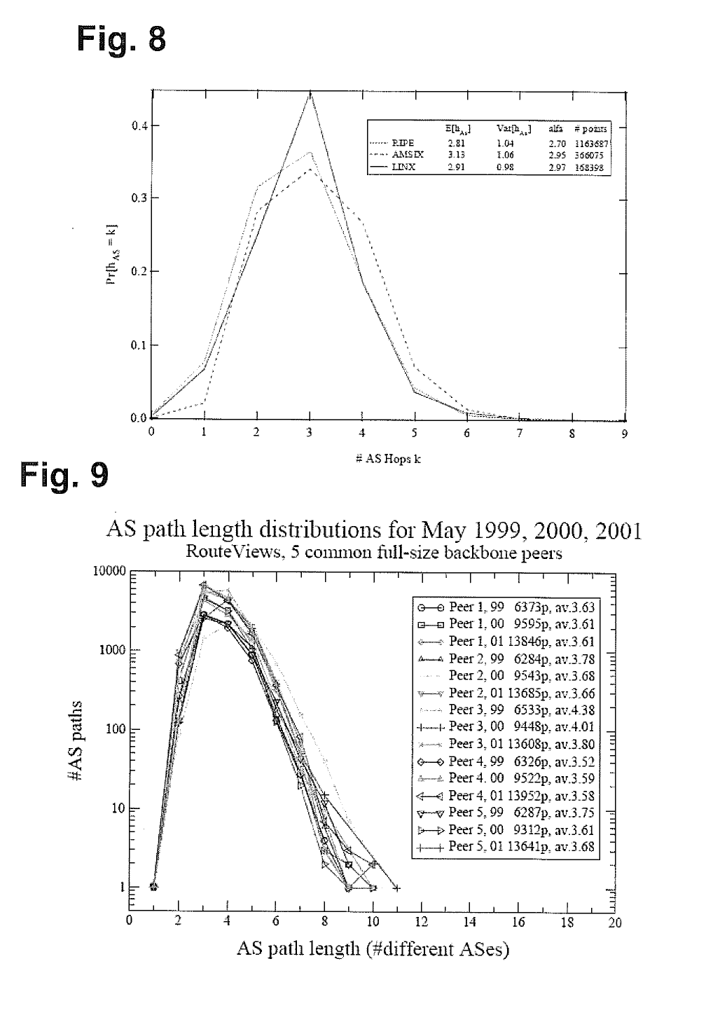

FIGS. 8 and 9 show the AS hop-count distance distribution collected by different providers.

FIG. 8 illustrates the autonomous system (AS) hop-count distance distribution observed by three different Remote Route Collectors: RIPEs, AMSIX, and LINX. RIPE is one of five Regional Internet Registries (RIRs) for the provision of Internet resource allocations, registration services, and coordination activities that support the operation of the Internet globally (URL: http://www.ripe.net). AMS-IX is the Amsterdam Internet Exchange (URL: http://www.ams-ix.net).

FIG. 9 illustrates the AS hop-count distance distribution observed by 5 backbone routers (peers) observed in three different years (1999, 2000, and 2001).

FIGS. 8 and 9 agree on an average number of AS hops between 3 and 4, with peaks around 10. The figures show that in average a packet traverses at least three Autonomous Systems along its path. This means that in average each packet triggers 3 or more IP lookup operations.

Embodiments of the present invention operate instead such that every packet undergoes only one IP lookup. For a given network forwarding capacity, this translates into a three-fold reduction in the amount of deployed TCAM capacity.

Accordingly, what has been disclosed are a methods, processes and systems for reducing address lookups in routing message packets across a multi-AS domain network having a net effect of savings in both power and cost.

Note, in the preceding discussion a person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

Numerous modifications, variations and adaptations may be made to the embodiment of the invention described above without departing from the scope of the invention, which is defined in the claims.

What is claimed is:

1. A method of routing a message packet having a destination address across a plurality of MPLS domains in a network, said method comprising the steps of:
receiving said message packet at an ingress port of a Label Sequencing Edge Router;
determining by said Label Sequencing Edge Router based upon said destination address a Label Sequence sufficient to traverse those intervening MPLS domains of said plurality of MPLS domains between said Label Sequencing Edge Router and said destination address;
modifying by said Label Sequencing Edge Router the header of said message packet by affixing said Label Sequence to said header; and
forwarding by said Label Sequencing Edge Router said message packet with modified header into the MPLS tunnels denoted by said Label Sequence.

2. A method as claimed in claim 1 wherein
said Label Sequence comprises a plurality of MPLS shim headers and wherein each MPLS shim header contains a label identifying a respective tunnel of said intervening MPLS domains.

3. A method as claimed in claim 2 wherein
said MPLS shim headers are inserted in an order with respect to the sequence of said intervening MPLS domains along the packet route defined by said Label Sequence.

4. A method as claimed in claim 3 wherein
said order is a reverse order with respect to the sequence of said intervening MPLS domains along the packet route defined by said Label Sequence such that the outer label closest to the MAC header identifies a tunnel in the first MPLS domain to be traversed, and such that the innermost label closest to the IP header identifies a tunnel in the last MPLS domain to be traversed.

5. A method as claimed in claim 2 wherein an egress Label Edge router at a peering point between an adjacent pair of intervening MPLS domains performs the additional steps of:
modifying the Label Sequence within the header of said message packet; and
subsequently forwarding the message packet to the adjacent MPLS domain.

6. A method as claimed in claim 5 wherein the modifying step comprises:
removing the topmost remaining MPLS shim header.

7. A method as claimed in claim 1 wherein said determining step comprises retrieving a Label Sequence from a data store according to said destination address.

8. A method as claimed in claim 7 wherein if said retrieving step cannot locate a Label Sequence in said data store, then said Label Sequence Edge Router performs the additional step of initiating a Label Sequence discovery process.

9. A method as claimed in claim 8 wherein said initiating step comprises requesting a Label Sequence from a Path Computation Element.

10. A method as claimed in claim 9 wherein said Path Computational Element is an element in a centralized Path Computational Element architecture.

11. A method as claimed in claim 9 wherein said Path Computational Element is an element in a distributed Path Computational Element architecture.

12. A Label Sequencing Edge Router for forwarding a message packet having a destination address across a plurality of MPLS domains in a network, said Label Sequencing Edge Router comprising:
an ingress port for receiving said message packet;
a Label Sequence data store for storing Label Sequences appropriate to specific destination addresses;
a header modifier for modifying the header of said message packet by affixing a Label Sequence retrieved from said Label Sequence data store; and
an egress port for forwarding said message packet with modified header into the MPLS tunnels denoted by said Label Sequence.

13. A Label Sequencing Edge Router as claimed in claim 12, further comprising:
a Label Sequence requester for requesting Label Sequences from a Path Computation Element.

14. A Label Sequencing Edge Router as claimed in claim 13, wherein
said Label Sequence requester is adapted for requesting Label Sequences from a centralized architecture Path Computation Element.

15. A Label Sequencing Edge Router as claimed in claim 13, wherein
said Label Sequence requester is adapted for requesting Label Sequences from a distributed architecture Path Computation Element.

16. An article of manufacture for use in programming a Label Sequencing Edge Router, the article of manufacture comprising tangible and non-transitory computer useable media accessible to the Label Sequencing Edge Router, wherein the computer useable media includes at least one computer program that is capable of causing the Label Sequencing Edge Router to perform the steps of:
receiving a message packet having a destination address at an ingress port of said Label Sequencing Edge Router;
determining by said Label Sequencing Edge Router based upon said destination address a Label Sequence sufficient to traverse those intervening MPLS domains of said plurality of MPLS domains between said Label Sequencing Edge Router and said destination address;
modifying by said Label Sequencing Edge Router the header of said message packet by affixing said Label Sequence to said header; and
forwarding by said Label Sequencing Edge Router said message packet with modified header into the MPLS tunnels denoted by said Label Sequence.

17. An article of manufacture as claimed in claim 16 wherein
said Label Sequence comprises a plurality of MPLS shim headers and
wherein each MPLS shim header contains a label identifying a respective tunnel of said intervening MPLS domains.

18. An article of manufacture as claimed in claim 17 wherein
said MPLS shim headers are inserted in an order with respect to the sequence of said intervening MPLS domains along the packet route defined by said Label Sequence.

19. An article of manufacture as claimed in claim 18 wherein
said order is a reverse order with respect to the sequence of said intervening MPLS domains along the packet route defined by said Label Sequence such that the outer label closest to the MAC header identifies a tunnel in the first MPLS domain to be traversed, and such that the innermost label closest to the IP header identifies a tunnel in the last MPLS domain to be traversed.
